(19) United States
(12) Patent Application Publication
(10) Pub. No.: US 2012/0089303 A1
(43) Pub. Date: Apr. 12, 2012

(54) Holding device and method for holding a vehicle occupant in a vehicle seat

(76) Inventors: Heiko Freienstein, Weil Der Stadt (DE); Jens Schrader, Baden-Baden (DE)

(21) Appl. No.: 13/138,561

(22) PCT Filed: Jan. 11, 2010
(86) PCT No.: PCT/EP2010/050189

§ 371 Date: Nov. 30, 2011

(30) Foreign Application Priority Data
Mar. 10, 2009 (DE) 102009001426.8

(51) Int. Cl. B60R 21/02; B60R 21/01

(52) U.S. Cl. 701/45; 280/748

(57) ABSTRACT

A holding device (195) for holding a vehicle occupant (180) in a vehicle seat (190); the center of mass (S) of the vehicle occupant (180) being in a predetermined center-of-mass region (330) over a vehicle seat surface when the vehicle occupant (180) sits on the vehicle seat (190); and the holding device (195) including a holding element (195) that is designed to hold the vehicle occupant (180) in a predetermined position on the vehicle seat (190) in the event of a collision of the vehicle. In addition, the holding device (195) includes a positioning unit (305, 710) that is designed to bring the holding element (300, 700) from a starting position into a target position on a side of the vehicle seat in response to an activation signal; in the target position, the holding element (300, 700) being situated at an elevation over the vehicle seat surface, so that in the target position, it laterally covers at least a part of the center-of-mass region (330).

### BACKGROUND OF THE INVENTION

1. Field of the Invention

The present invention relates to a holding device for holding a vehicle occupant in a vehicle seat, as well as a method for holding a vehicle occupant in a vehicle seat.

2. Description of Related Art

In recent times, an increasing number of requirements have been set for the safety of vehicle occupants in passenger cars. This results from stringent legal requirements for the corresponding safety of people, as well as from consumer tests of corresponding consumer protection organizations that are difficult to pass. In this context, special attention is given, in particular, to the risk of injury to the thorax of a vehicle occupant, since sensitive inner organs not particularly well protected are present in this bodily region.

In order to ensure that these body parts are protected as much as possible, the related art often employs airbags in the form of a front airbag, a side airbag or a head airbag. However, these air bags only function optimally when the vehicle occupant is in a predetermined position and is not taken out of this position by the forces occurring during the collision. In order to hold the occupant in this position, a seatbelt is often used which is intended to hold the vehicle occupant in the corresponding, predetermined position in the vehicle seat. In this context, however, it should be noted that this seatbelt, which is mostly designed as a 3-point seatbelt, covers a large region of the upper body and therefore locks it in position; however, in the case of a side impact or in the case of extreme occupant sitting positions, the effectiveness of the belt is limited: in the case of a collision, the vehicle occupant can slide from the vehicle seat, underneath the seat belt, through to the side or to the front, so that shortly after a collision, the vehicle occupant is no longer in the optimal region of action of the airbag(s).

In order to prevent such lateral sliding-away, published international patent application document WO 2004103779 A1 proposes an active seat, which is controlled as a function of a sensory system (e.g., a monitoring system of the surroundings of the vehicle). If, for example, an approaching vehicle or a collision of an object with the reference vehicle is detected, a side plate mounted in the seat may be reversibly set up or moved forward electrically, pneumatically or via a spring drive. However, using this extended side plate, a vehicle occupant can still slip through, under the seat belt, to the side or to the front.

### BRIEF SUMMARY OF THE INVENTION

Against this background, the present invention introduces a holding device, furthermore a method of holding, a control device that uses this method, and finally a corresponding computer program product.

The present invention provides a holding device for holding a vehicle occupant in a vehicle seat, the center of mass of the vehicle occupant being in a predetermined center-of-mass region over a vehicle seat surface when the vehicle occupant sits on the vehicle seat, and the holding device including the following features:
a holding element that is designed to hold the vehicle occupant in a predetermined position on the vehicle seat in the event of a collision of the vehicle; and
a positioning unit that is designed to bring the holding element from a starting position into a target position on a side of the vehicle seat; in the target position, the holding element being situated at an elevation over the vehicle seat surface, so that in the target position, it laterally covers at least a part of the center-of-mass region.

In addition, the present invention provides a method for holding a vehicle occupant in a vehicle seat; the center of mass of the vehicle occupant being in a predetermined center-of-mass region over a vehicle seat surface when the occupant sits on the vehicle seat; and the method including the following step:
extension of a retaining element out of a starting position into a target position in response to an activation signal, the extension being implemented, such that retaining element is brought into a target position on a side of the vehicle seat; and in the target position, the holding element being situated at an elevation over the vehicle seat surface, so that in the target position, it laterally covers at least a part of the center-of-mass region.

The present invention also provides a method for triggering a restraining device for protecting a vehicle occupant in the event of a collision, the method including the following features:
detecting a position of a holding element, which, with regard to the vehicle seat, is designed to be brought into a lateral target position at an elevation over the vehicle seat surface at which a center of mass of the vehicle occupant is situated; and
controlling the triggering of the restraining device, using the detected position of the holding element.

Finally, the present invention provides a control device, which is designed to execute steps of one of the above-mentioned methods, as well as a computer program for controlling steps of one of the above-mentioned methods when the computer program is executed on a data processing system. In the case at hand, a control device may be understood as an electric device that processes sensor signals and outputs control signals as a function thereof. The control device may have an interface, which may be implemented as hardware and/or software. In a hardware design, the interfaces may, for example, be part of a so-called system ASIC that contains various functions of the control device. However, it is also possible for the interfaces to be separate, integrated circuits or to be at least partially made up of discrete components. In a software design, the interfaces may be software modules that are present on a microcontroller in addition to other software modules, for example. Also advantageous is a computer program product having program code, which is stored on a machine-readable medium such as a semiconductor memory, a hard-disk memory or an optical memory and is used to implement the method according to one of the specific embodiments described above, when the program is executed in a control device.

The present invention is based on the insight that effective protection of an occupant from slipping out laterally or forwardly under a seat belt may be improved, when a holding element is positioned or extended laterally to or in the occupant seat, so that the holding element is situated in a target position laterally adjacent to the occupant seat, at an elevation at which the center of mass of the vehicle occupant (which is located, for example, in the thorax) is situated. By this means, the vehicle occupant may be effectively held in the desired position on the vehicle seat, so that the primary safety or restraining device, such as an airbag, may operate optimally. Consequently, the positioning of the holding element at an elevation over the seat surface of the vehicle seat, at which elevation the center of mass of the vehicle occupant is normally situated, assists further safety devices, such as the seatbelt, at the location at which, in the event of a collision, a high force acts due to the contact of the center of mass of the vehicle occupant, the high force possibly not being able to be sufficiently absorbed by the further safety device (that is easy to wear during the drive). However, it is also possible to position the holding device, alone, in the pelvic region of the vehicle occupant, since the holding device of the present invention may allow, in the event of a collision, a majority of the forces acting on the vehicle occupant in the region of his or her center of mass to be absorbed. When designing the holding device proposed at this juncture, one may, in so doing, take advantage of the fact that the center of mass of vehicle occupants (e.g., ascertained using an average size of adult persons in Germany or Europe) mostly varies within a very narrow range, which means that the mounting of the holding element in the target position may be implemented in a relatively narrowly limited region. For example, this target position may be situated at an elevation of 10 to 45 cm over the seat surface of a vehicle seat, laterally adjacent to the vehicle seat. In order to bring the holding element into such a target position, e.g., it may be extended out of lateral flanks of the seat surface, or out of lateral flanks of the seat back of the vehicle seat. In addition, the present invention may allow an extended holding element or its current position to be taken into account in the triggering of a restraining device. Thus, for example, a side airbag may possibly be switched off, if the current position of the holding element ensures that the vehicle occupant cannot slide from the intended position in the vehicle seat and the action of the frontal airbag is optimal. This, in turn, would reduce costs, since after a collision, e.g., only the front airbag would have to be replaced, and the side paneling would not have to be provided with a new side airbag.

Therefore, the present invention provides the advantage that a marked improvement in the fixing of the vehicle occupant in position in the vehicle seat is possible, which means that the vehicle occupant may no longer be able to slide through, under the seat belt, to a side or to the front. This, in turn, may improve the possibility for using further safety or restraining devices, which means that on the whole, the safety of a vehicle occupant in the event of a collision is increased. In addition, the prevention of the triggering of unneeded, irreversible restraining devices may reduce the costs of repairing the vehicle after a collision.

In a particular embodiment of the present invention, the positioning unit may be designed to bring the holding element into a target position, so that in the target position, the holding element laterally covers at least a part of the center-of-mass region, in which the center of mass of at least 80 percent, in particular, at least 95 percent, of the persons that come into consideration as vehicle occupants on the vehicle seat is situated. Such a specific embodiment of the present invention offers the advantage that nearly all vehicle occupants may benefit from the increase in safety rendered possible by the holding device. Consequently, the holding element covers nearly completely the region in which the center of mass of the vehicle occupant is normally situated, which means that in the event of a collision, the vehicle occupant has a very high probability of no longer being able to slide out of the desired, predetermined position on the vehicle seat. In this context, in particular, a position of the center of mass of an adult occupant is to be used as a baseline, so that the position of the center of mass of a designated portion of the occupants in question may be determined from the official statistics regarding the size of the population (e.g., in Germany or in Europe).

The positioning unit may also be designed to bring the holding element into the target position in a movement having a curved trajectory, in particular, in a crescent-shaped movement. Such a specific embodiment of the present invention provides the advantage that, in the event of a collision, a possible movement of the vehicle occupant may be gently absorbed, and the vehicle occupant does not impinge against an object suddenly situated in his or her path of motion.

In addition, the positioning unit may be designed to move the holding element away from the vehicle seat in a first movement and towards the vehicle seat again in a second movement; after the second movement, at least a portion of the holding element being situated in the target position, in order to hold the occupant in the predetermined position; Such a specific embodiment of the present invention also may allow the occupant to be gently cushioned; e.g., the holding element initially being extended diagonally forwards out of a side plate of the seat back of the vehicle seat, in the direction of a vehicle door, and subsequently folded back in the direction of the thorax of the vehicle occupant. A similar movement may be executed out of the side frame of the seat cushion, in order to further improve occupant restraint. In this instance, the holding device is moved diagonally upwards out of the seat surface and, in the second part of the movement, towards the thighs.

Furthermore, in another specific embodiment of the present invention, the positioning unit may also be designed to move the holding element in two different directions in succession. Such a specific embodiment of the present invention provides the advantage that the holding element may be moved at different speeds in the two different directions. This may allow the holding element to be extended rapidly in a first direction, in order to advance the holding element as closely as possible to the target position. Hereafter, the holding element may be brought into the final position in a slower movement of the holding element, particularly sharp attention being able to be paid to gently cushioning the vehicle occupant.

In order to ensure that the holding element is brought rapidly into the target position, the positioning unit may be designed to extend the holding element out of a seat back or a seat surface of the vehicle seat. If the holding element is already held up in the vehicle seat in a starting position, it may be moved out very rapidly into the lateral target position close to the occupant.

In addition, the positioning unit may be designed to position the holding element in the target position in such a manner, that it has a flank facing the occupant that is positioned at an angle of greater than 45 degrees, in particular, at an angle of greater than 80 to 90 degrees, to the vehicle seat surface. Such a specific embodiment of the present invention provides the advantage that the very steep to nearly perpendicular flank of the holding element in the seat cushion and the seat back may highly effectively prevent the vehicle occupant from sliding away from the seat surface and the upper part of the vehicle seat from tilting. In this connection, in particular, a side plate of the vehicle seat may be extended, a larger angle of the flank of the holding element also increasing the force necessary to move the vehicle occupant up at this flank. Consequently, in such a specific embodiment, the vehicle occupant may be cushioned very gently, since when the holding element is extended, this angle is increased more and more, and ultimately, in the extended state, the holding element either pushes the vehicle occupant back into the original position or at least effectively prevents him or her from sliding further away.

It is also favorable for the positioning unit to be designed to bring the holding element from a starting position into the target position in a time span of not more than 2 seconds, in particular, in a time span of not more than 800 milliseconds. Such a specific embodiment of the present invention provides the advantage that after the occurrence of a collision, the holding element may be brought into the target position in a timely manner and therefore may achieve its optimum protective effect. This is achieved in conjunction with, for example, a suitable sensory system (inertial sensor system or predictive sensory system), which already triggers the positioning unit prior to contact with the opposing party in the collision.

In order to allow timely activation of the holding device, which does not generate any unnecessary expenses in the event of possible erroneous triggering, the positioning unit may also be designed to bring back the holding element from the target position into a starting position again. Such a specific embodiment provides the advantage that the early extension of the holding element at a time of collision may allow effective protection of the occupant to already be provided and the further safety devices to operate in an optimum manner. In this case, the triggering time for the irreversible restraining devices may also be selected to be longer, which means that this longer time span may allow a collision that it actually occurring to be detected more reliably. For if the irreversible restraining devices are triggered too early and unnecessarily, the cost of repairing the vehicle is markedly higher.

In addition, according to a further embodiment of the present invention, it is possible to design the positioning unit to detect, upon extension of the holding element, a resistance to the extension and to further extend or stop the extension of the holding element on the basis of the detected resistance. Such a specific embodiment of the present invention provides the advantage that possible pinning of occupants on the occupant seat or a case of misuse may be detected and prevented.

It is also favorable for the holding device to further have a second holding element that is designed to hold the vehicle occupant in a predetermined position on the vehicle seat; and the positioning unit further being designed to bring the second holding element into a second target position on a side of the vehicle seat, opposite to the target position with respect to the vehicle seat; in the second target position, the second holding element being situated at an elevation above the vehicle seat surface, so that in the second target position, it laterally covers at least part of the center-of-mass region. Such a specific embodiment of the present invention having holding elements situated on both sides of the vehicle seat provides the advantage that the vehicle occupant may be held in a highly effective manner in the predetermined position and does not slide away out of this position due to skidding in various directions from the forces at the time of the collision and shortly thereafter.

### BRIEF DESCRIPTION OF THE DRAWINGS

In the following, the present invention is explained in greater detail by way of example, with reference to the attached drawing. The figures show:

FIG. 1 shows a block diagram of an occupant protection system of a vehicle, having sensors, restraining devices and the holding device of the present invention, according to an exemplary embodiment of the present invention.

FIG. 2 shows a representation of an interaction of the different safety and restraining devices, as well as of an action of these devices on an occupant.

FIG. 3 shows a graphic representation of a first exemplary embodiment of the present invention in the form of a holding device.

FIG. 4a-b show schematic representations of the application of forces to the holding element during the extension of the holding element, at different times of a collision.

FIG. 5a-b show schematic representations of a further exemplary embodiment of the present invention in the form of a holding device, in different positions upon extending the holding element during a collision

FIG. 6 shows a flow chart of an exemplary embodiment of the present invention in the form of a method.

FIG. 7 shows a flow chart of a further exemplary embodiment of the present invention in the form of a method.

### DETAILED DESCRIPTION OF THE INVENTION

In the following figures, identical or similar elements may be provided with the same or similar reference numerals.

Furthermore, the figures in the drawing, their description and the claims contain numerous features in combination. In this context, it is clear to one skilled in the art that these features may also be considered individually or may be combined to form further combinations not explicitly described here. The dimensions and sizes named in the following are used only to illustrate the description of the present invention and are not to be understood as a limitation of the present invention to these sizes and dimensions.

In the case of a collision, the approach proposed here is intended to have a protective effect on the occupant and, in addition, support and improve the protective action of other systems. For both the case of side impact (on the crash side and on the side opposite to the occupant (far side)) and in situations of front-end or rear-end impact, as well as in rollover situations, the approach proposed here is intended to contribute to the occupant being held in an optimum position for as long as possible. In this manner, the provided survival space determined by construction is completely utilized, and all restraint and safety systems may operate in an optimum manner.

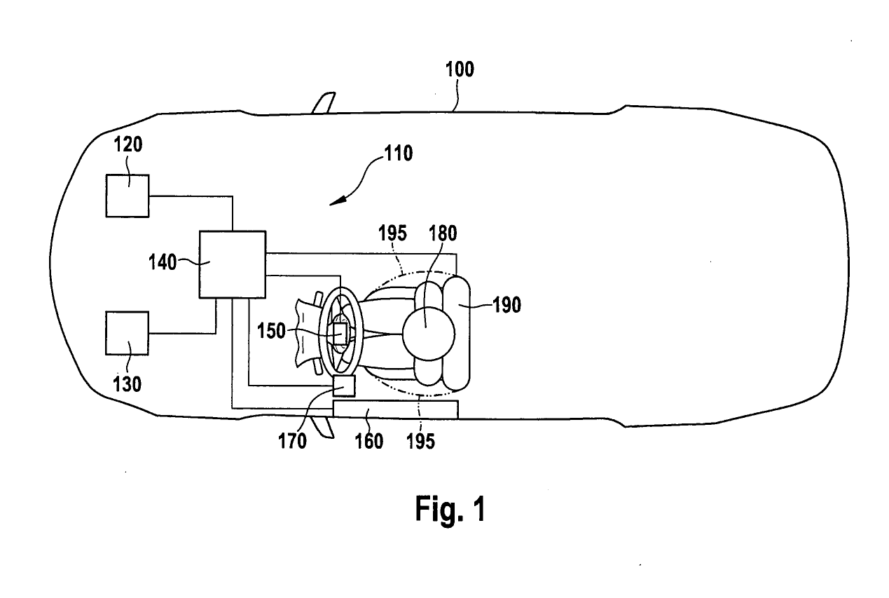

To clearly represent the present invention in cooperation with further components, FIG. 1 shows a block diagram of an occupant protection system 110 of a vehicle 100, which includes the holding device according to an exemplary embodiment of the present invention. Occupant protection system 110 includes, for example, a plurality of sensors for detecting a situation regarding surroundings, the sensors being provided, e.g., in the form of a radar sensor 120 for detecting an approach of another vehicle or an acceleration sensor 130 for detecting an impact in the event of a collision of the other vehicle with (reference) vehicle 100. The signals of the two sensors 120 and 130 may be processed in an evaluation unit 140 or a control device, which then activates the corresponding safety devices. Depending on the necessary situation, a front airbag 150 in a steering wheel or out of the instrument console of vehicle 100, a side airbag 160 in a door or the seat of vehicle 100 or a head airbag 170 in a roof girder of vehicle 100 may be deployed as safety devices, in order to prevent an impact of vehicle occupant 180 with corresponding structural components of vehicle 100. However, to prevent vehicle occupant 180 from sliding away out of vehicle seat 190, a holding device 195 described below in further detail may be activated, the holding device being moved out laterally to vehicle seat 190 and holding vehicle occupant 180 in an optimum position for airbags 150, 160 and 170, in order that vehicle occupant 180 falls, as centrally and optimally oriented as possible, into the corresponding, inflated airbags and may be prevented from laterally sliding away from the corresponding airbags.

The approach presented here may be regarded, for example, as a further development of the possibilities indicated in the description of the related art. As a function of a signal that is output, for example, by the evaluation unit 140 represented in FIG. 1, holding device 195 may be implemented in the form of a vehicle-seat side plate in the seat surface and seat back, the vehicle-seat side plate being extended prior to the actual impact of another vehicle with the reference vehicle, so that the lateral side support of occupant 180 is improved. In addition to sensors 120 and 130 represented in FIG. 1, further sensors, which use, for example, radar, video, stereo-video, range video (PMD/time of flight) ultrasonic or lidar may be considered as sensor technology that provides the corresponding collision signals to corresponding evaluation unit 140. In addition, it is highly advantageous to trigger the holding device, using reversible actuator technology, on the basis of inertial sensor technology and vehicle-dynamics sensor technology.

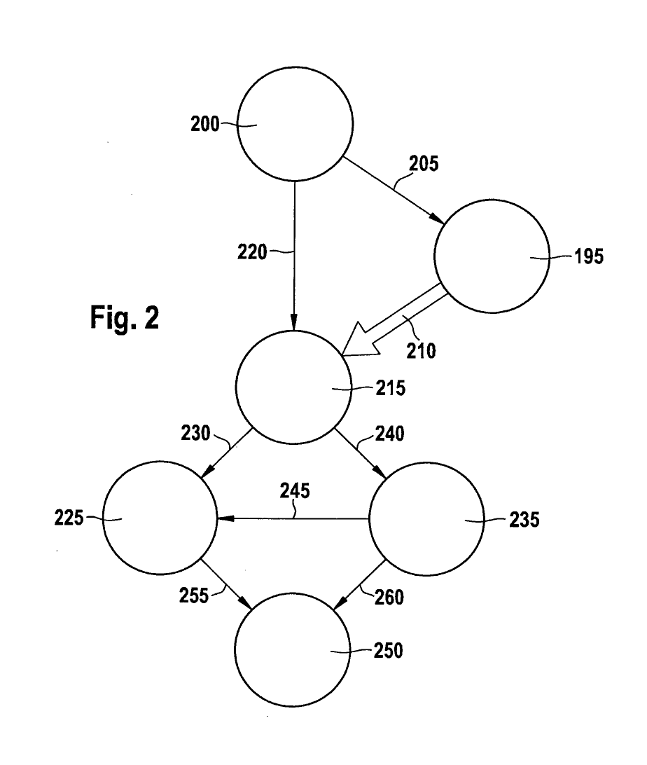

The holding device presented below in greater detail (which is also referred to as ESA (enveloping side adjustment) in the further description), together with, in particular, restraint systems already present, improves the operation of these restraint systems, as is schematically represented in a “choreography of the restraint systems” of a side impact of another vehicle with the reference vehicle, shown in FIG. 2. The operational context and the system-specific advantages may be gathered from the depiction of FIG. 2 and may be described as follows.

First of all, the seat and a seat belt 200, a torso airbag, a head airbag and the ESA, i.e., holding device 195, are provided as restraining devices. The introduction of holding device 195 is supported by belt 200 (arrow 205) and very sharply inhibits (arrow 210) a lateral occupant movement 215 towards the impact side of the other vehicle; belt 200 also inhibits lateral occupant movements 215 in a certain manner, but not so markedly, the inhibition of lateral occupant movements via the belt being symbolized by arrow 220. Such lateral occupant movements 215 would markedly reduce a size of a survival zone 225, which is symbolized by arrow 230. The effective operation of airbag 235, in particular, its effective volume, would also be limited by lateral occupant movements 215 (in accordance with arrow 240), but a larger airbag 235 would increase the size of survival zone 225 (in accordance with arrow 245). However, a large survival zone 225 reduces the severity of injury 250 (in accordance with the operational interrelationship as shown by arrow 255), and a large airbag volume 235 also reduces corresponding severity of injury 250 (corresponding to arrow 260).

Consequently, by limiting the lateral occupant movements, the introduction of holding device 195 leads to improved protective action by the remaining restraining devices. Furthermore, there is the possibility that the holding device also may improve the operation of the side airbag, which then provides a larger effective volume.

In comparison with the related art, in the holding device provided here, the specific trajectory of the side plate in the form of a holding device, in particular, in the aspects of direction, path, angle of conformity and superposition of the translation with the pneumatic enclosing, is to be especially emphasized; in particular, the path goes far above and beyond the typical path of the holding element according to the related art and fixes the occupant in position in the vehicle seat. Furthermore, a detailed description of the design of the side plate, including the actuator technology and position sensor technology, is now described anew. In addition, a force limitation of the side plate takes place, and a description of the interaction with the remainder of the restraint system and an algorithm for dynamic adaptation of the entire restraint system are given.

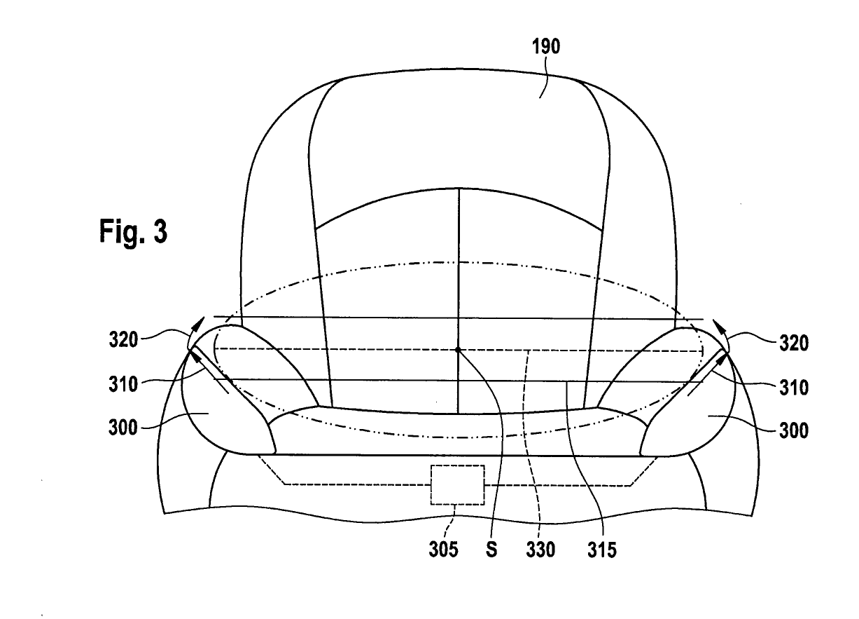

In the following description, the operating principle of the approach presented here is described in further detail. In comfort mode, the actuators of the holding device may be adapted manually by the occupant, or also automatically or semi-automatically, to the requirements of a comfortable ride. An operating-dynamics lateral support or an active seat-back width adjustment in known upper-class vehicles may be mentioned as an example, which may also be used in vehicle seats having the holding device. In the case of a precrash detection (that is, a detection of a directly imminent collision before the actual collision has taken place), side plates 300 (in the form of a holding element of the holding device) of the seat are moved out in such a manner, that the occupant is not pushed out of the seat but, on the contrary, experiences additional lateral support. The method is implemented in one or more phases. Side plates 300 of the seat back and/or the side plates of the seat surface may be driven or moved jointly or, depending on the danger situation, also individually (by a positioning unit 305 concealed in vehicle seat 190 and therefore represented in FIG. 3 by a dashed line), as is apparent from the graphical representation of FIG. 3. Positioning unit 305 may be an electromotive or pneumatic unit, which may move holding element 300 in different directions and adjust it. Initially, side plate 300 (or the two side plates 300, either simultaneously or temporally staggered) may be moved in a first direction 310, in order to be subsequently driven in a second direction 320 in the direction of the occupant. In general, all suitable machine elements, individually or in combination, are conceivable as actuators of positioning unit 305, for example, an electric motor having a gear rack/cam disk, pneumatic cylinders and/or bags, spring elements having an electromagnetic or other trigger mechanism.

The mode of operation may be clarified in view of the following representation of FIG. 3, using the example of seat-surface side plates 300. However, FIG. 3 may also be interpreted, such that illustrated site plates 300 are side plates of a seatback of the vehicle seat (in a plan view), the mode of operation of the present invention being substantially identical in the two scenarios.

Since side plates 300 are elastic for reasons of comfort, the effective restraining geometry in the collision is considerably smaller than the geometry of the side plates in the resting state. In conventional seats, center of mass S of the upper body of a vehicle occupant is typically situated outside of the effective restraining geometry, in a special center-of-mass region 330. In this context, in the case of different people sitting in the vehicle seat, use can be made of the fact that center of mass S is situated in a very narrow region over the vehicle seat surface, which means that it can be assumed that center-of-mass region 330 (which is represented in FIG. 3 as line 330) is small. For example, this elevation of center of mass S of the occupant, i.e., the center-of-mass region, is approximately 10 to 30 cm (but sometimes up to 60 cm, as well) over the seat surface of the vehicle seat. Furthermore, center of mass S of the occupant may also be situated in a distance range of 10 to 30 cm away from the seatback of the vehicle seat.

In the case of a lateral crash, the related art supports the occupant insufficiently (since side plate 300 only extends far enough to cover a region up to marking 315). Consequently, the occupant slides up the contour of a side plate 300 or rolls over it, out of seat 190. However, if the present invention provides for side plate 300 to be extended further prior to the crash so as to cover center-of-mass region 330 (as has occurred after the execution of second movement 320, as shown in FIG. 3), upper-body center of mass S of the occupant is situated inside of the effective restraining geometry. In this context, the center-of-mass region may include a region, which is represented in FIG. 3 between the solid lines below and above center of mass S; however, it may also be correspondingly smaller and extend essentially around the line 330 represented as dashed in FIG. 3. In addition, if side plate 300 is set up more steeply, all of the kinetic energy of the occupant may be absorbed and the upper body may be held in its position.

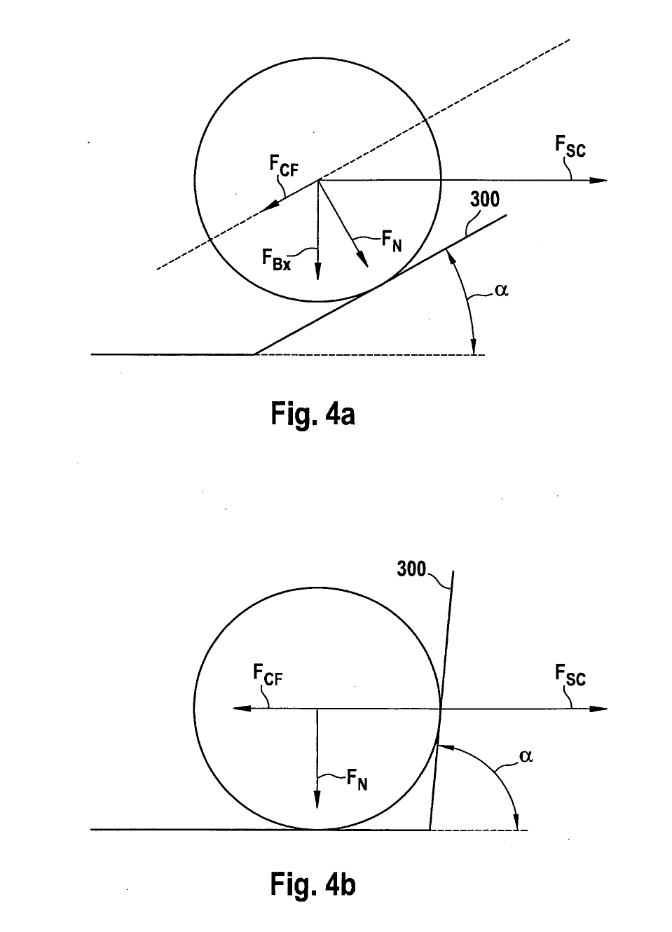

Supportive of this function is the action of a belt having, preferably, a belt tensioner. This restrains the occupant, so that center of mass S remains behind the restraining geometry of the side plates and, in addition, the friction between the occupant and the seat back may act to reduce acceleration. In the present invention, an (anti-crash) angle a between side-plate upper surface 300 and the seat surface (or seatback) greater than 45° is desired, as is supposed to be indicated in FIG. 4a. In this representation, it is discernible that in the event of a force F_{SC} from a side impact, a normal force F_{N} and a force F_{Bx} of a seatbelt in an x direction, a friction force F_{CF}. (CF=coulomb friction; F_{CF}=μ_{C}F_{N}; μ_{C}=coefficient of friction between textiles and textiles or leather) is generated, which prevents the occupant from sliding up on the contour of the side plate. In FIG. 4b, a picture is represented in which an angle α is nearly 90° (which is theoretically attainable), which means that steep side plate 300 allows highly effective restraining action to be achieved. By this means, a very strong restraining force may be generated so that the occupant may be optimally held in the desired position.

During the adjustment of the side-support contour, it may also be advantageous to detect, e.g., using suitable (pressure) sensors, or by measuring the increase in current in the electric motor, if a resistance to the adjustment increases. In this manner, the pinching of occupants or misuse could be detected and prevented.

Therefore, in comfort systems, both electromotive actuators and pneumatic actuators may be used for adjusting the side plates. These actuators should be modified as follows:
The adjusting speed should be large enough to allow the side plates to be moved along the required trajectory within an early-warning time from the detection of an imminent collision up to the actual collision. For example, the side plates should be able to be moved out into the target position at a speed of less than 2 seconds, and preferably, at a speed of less than 800 ms.
The rigidity and robustness of the actuators should be sufficient to be able to absorb the crash or collision forces and divert them into the seat structure.
A force limiter should be provided (for example, in the positioning unit), in order to prevent an occupant from being injured due to the restraining forces.

In addition, measures may also be advantageously taken to detect the adjusting path of the side plates. This is possible at the actuator, e.g., using a pressure sensor or Hall-effect sensor, or else directly via capacitive or inductive displacement measurement, potentiometer(s), or limit stops via a force limiter, photoelectric barriers or reed contacts.

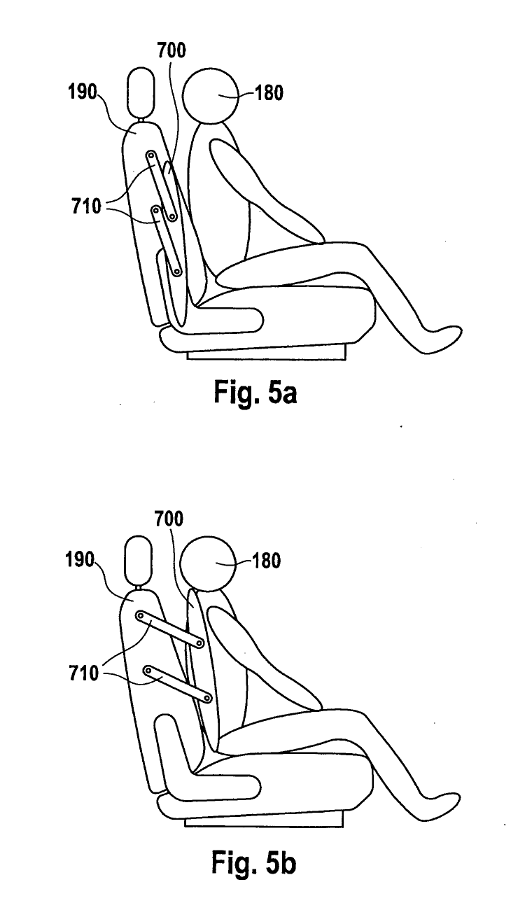

FIG. 5 shows a further exemplary embodiment of the present invention in the form of a holding device. In this connection, holding element 700 is provided in the seat back of vehicle seat 190 in a starting position (see FIG. 5a); immediately prior to a collision, the holding element being folded out of seat back 190 by a positioning unit 710 and giving vehicle occupant 180 additional lateral support (see FIG. 5b).

The folding-out may be accomplished by implementing the device for improving the lateral support, using a springed system 710 as a positioning unit. In the normal position (FIG. 5a), side plate 700 is then in a comfortable position. Side plate 700 is extended (FIG. 5b) by activating a prestressed spring after a triggering signal.

In the above-described exemplary embodiments, it may also be particularly advantageous that after activation of the precrash status, the adjustment of the holding element may be interrupted at any time. After activation of the precrash status, if the system has information that allows a reliable conclusion that the expected crash is not occurring, then the adjustment procedure is interrupted and the side plate(s) is/are brought again into the initial state or a stored, user-specific, desired state. The longer the early-warning time, the more unreliable the crash or collision prediction. If the precrash status is set too rapidly and too early, then false releases, e.g., of irreversible restraining devices, occur. If such false triggering may be detected rapidly enough by the system and the adjustment procedure may be interrupted, then this reduces injury to the occupant by instances of false triggering. First of all, this leads to a higher acceptance of the system, and secondly, it allows the possibility of increasing the early-warning time without the negative effects of false releases.

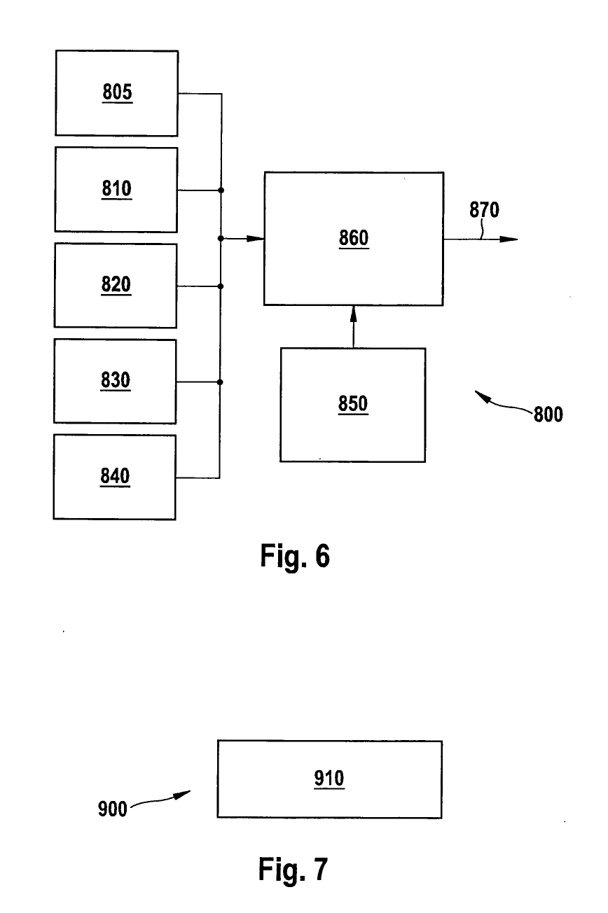

An advantageous embodiment of the present invention in the form of a triggering algorithm for a method 800 for improving the triggering of components of the remaining, irreversible restraint system (airbags and belts) is shown in the following with the aid of FIG. 6. In this context, FIG. 6 shows an operational interrelationship diagram of above-mentioned method 800 in the form of an exemplary embodiment of the present invention. In addition to the detection of crash or collision signals (e.g., from collision acceleration sensor 805 in a y direction, collision pressure sensor 810, a collision, acceleration sensor 820 of the ECU in the y direction), surround signals from a surround sensor system 830, as well as further collision signals from a further collision sensor system 840, status 850 of the ESA or the holding device (for example, the position of side plate 300 or 700 or the degree of encirclement of the occupant) is also detected and included, via a corresponding signal, in the calculation or control 860 of triggering signal 870 for, e.g., a belt tensioner or a side air bag.

This inclusion of the status of the holding device in the determination of triggering 860 of the restraining devices has essentially two advantages:
Firstly, the time-to-fire (i.e., the time up to the triggering of the restraining device), and consequently, the interaction with the other restraining devices, may be optimized (the occupant moves differently when the ESA or holding device is extended).
Secondly, the robustness of the classification decision may also be positively influenced as a function of the ESA status. This may be achieved, for example, by raising the “fire threshold” in the case of an extended ESA: due to the improved lateral restraint action, the air bag may be deployed somewhat later, i.e., the triggering decision may be based on more measured values and is therefore more robust. A restraining device may not even need to be activated, which means that repair costs may be reduced.

Furthermore, the present invention also includes a method 900 (represented as a flow chart according to FIG. 7) for holding a vehicle occupant in a vehicle seat; the center of mass of the vehicle occupant being in a predetermined center-of-mass region over a vehicle seat surface when the occupant sits on the vehicle seat; and the method including the step of extending 910 a holding element out of a starting position into a target position in response to an activation signal; the extension being implemented, such that the holding element is brought into a target position on a side of the vehicle seat; and in the target position, the holding element being situated at an elevation over the vehicle seat surface, so that in the target position, it laterally covers at least a part of the center-of-mass region.

1-15. (canceled)

16. A holding device for holding a vehicle occupant in a vehicle seat; the center of mass of the vehicle occupant being in a predetermined center-of-mass region over a vehicle seat surface when the vehicle occupant sits on the vehicle seat; and the holding device comprising:
a holding element that is designed to hold the vehicle occupant in a predetermined position on the vehicle seat in the event of a collision of the vehicle; and
a positioning unit that is designed to bring the holding element from a starting position into a target position on a side of the vehicle seat in response to an activation signal; in the target position, the holding element being situated at an elevation over the vehicle seat surface, so that in the target position, it laterally covers at least a part of the center-of-mass region.

17. The holding device as recited in claim 16, wherein the positioning unit is designed to bring the holding element into a target position, so that in the target position, the holding element laterally covers at least a part of the center-of-mass region, in which the center of mass of at least 80 percent of the persons that come into consideration as a vehicle occupant on the vehicle seat is situated.

18. The holding device as recited in claim 16, wherein the positioning unit is designed to bring the holding element into a target position, so that in the target position, the holding element laterally covers at least a part of the center-of-mass region, in which the center of mass of at least 95 percent of the persons that come into consideration as a vehicle occupant on the vehicle seat is situated.

19. The holding device as recited in claim 16, wherein the positioning unit is designed to bring the holding element into the target position in a movement having a curved trajectory.

20. The holding device as recited in claim 16, wherein the positioning unit is designed to move the holding element in two different directions in succession.

21. The holding device as recited in claim 20, wherein the positioning unit is designed to move the holding element away from the vehicle seat in a first movement and towards the vehicle seat again in a second movement; after the second movement, at least a portion of the holding element being situated in the target position, in order to hold the vehicle occupant in the predetermined position.

22. The holding device as recited in claim 16, wherein the positioning unit is designed to move the holding element out of a seatback or a seat surface of the vehicle seat.

23. The holding device as recited in claim 16, wherein the positioning unit is designed to position the holding element in the target position in such a manner, that it has a flank, which faces the vehicle seat surface or the seatback and is positioned at an angle of greater than 45 degrees to the vehicle seat surface or a seatback.

24. The holding device as recited in claim 16, wherein the positioning unit is designed to position the holding element in the target position in such a manner, that it has a flank, which faces the vehicle seat surface or the seatback and is positioned at an angle of greater than 80 degrees to the vehicle seat surface or a seatback.

25. The holding device as recited in claim 16, wherein the positioning unit is designed to bring the holding element from a starting position into the target position in a time span of not more than 2 seconds.

26. The holding device as recited in claim 16, wherein the positioning unit is designed to bring the holding element from a starting position into the target position in a time span of not more than 800 milliseconds.

27. The holding device as recited in claim 16, wherein the positioning unit is designed to bring the holding element back from the target position into the starting position again.

28. The holding device as recited in claim 16, wherein upon moving the holding element out, the positioning unit is designed to detect a resistance to the moving-out and to further move out, or stop the moving-out of, the holding element on the basis of the detected resistance.

29. The holding device as recited in claim 16, further comprising a second holding element that is designed to hold the vehicle occupant in a predetermined position on the vehicle seat; and the positioning unit further being designed to bring the second holding element into a second target position on a side of the vehicle seat, opposite to the target position with respect to the vehicle seat, in response to the activation signal; in the second target position, the second holding element being situated at an elevation above the vehicle seat surface, so that in the second target position, it laterally covers at least part of the center-of-mass region.

30. A method for holding a vehicle occupant in a vehicle seat; the center of mass of the vehicle occupant being in a predetermined center-of-mass region over a vehicle seat surface when the vehicle occupant sits on the vehicle seat; and the method comprising:
moving a holding element out of a starting position into a target position in response to an activation signal, the moving-out being implemented, such that the holding element is brought into a target position on a side of the vehicle seat; and in the target position, the holding element being situated at an elevation over the vehicle seat surface, so that in the target position, it laterally covers at least a part of the center-of-mass region.

31. A method for triggering a restraining device for protecting a vehicle occupant in the event of a collision, the method comprising:
detecting a position of a holding element, which, with regard to the vehicle seat, is designed to be brought into a lateral target position at an elevation over the vehicle seat surface at which a center of mass of the vehicle occupant is situated; and
controlling the triggering of the restraining device, using the detected position of the holding element.

32. A non-transitory computer-readable data storage medium storing a computer program having program codes which, when executed on a computer, performs a method for triggering a restraining device for protecting a vehicle occupant in the event of a collision, the method comprising:
detecting a position of a holding element, which, with regard to the vehicle seat, is designed to be brought into a lateral target position at an elevation over the vehicle seat surface at which a center of mass of the vehicle occupant is situated; and
controlling the triggering of the restraining device, using the detected position of the holding element.
